(19) United States
(12) Patent Application Publication
(10) Pub. No.: US 2014/0089188 A1
(43) Pub. Date: Mar. 27, 2014

(54) SYSTEM FOR FUNDS TRANSFER USING SOURCE ATM AND DELIVERING ATM

(71) Applicant: BINDU RAMA RAO, LAGUNA NIGUEL, CA (US)

(72) Inventor: BINDU RAMA RAO, LAGUNA NIGUEL, CA (US)

(21) Appl. No.: 14/093,521

(22) Filed: Dec. 2, 2013

Related U.S. Application Data
(63) Continuation-in-part of application No. 13/277,300, filed on Oct. 20, 2011, now Pat. No. 8,639,602.

(51) Int. Cl. G06Q 20/10

(52) U.S. Cl. CPC G06Q 20/1085
USPC 705/43

(57) ABSTRACT

A system for conducting funds transfer using a source ATM and a delivering ATM. In one embodiment, a sender can use the source ATM to initiate a funds transfer, deliver cash into it, or a check, or select a bank account with sufficient funds available, to be the source of funds. The sender can even use his ATM card to login to the source ATM and provide a passcode or PINcode (such as a 4 digit PINcode) if challenged to be able to use the source ATM. Similarly, the recipient uses the delivering ATM to receive funds, providing a transaction id and security information (such as a security token, for example) when prompted by the user interaction screen and keyboard circuitry. The sender and the recipient need not have any bank accounts to conduct funds transfer.

### CROSS REFERENCES TO RELATED APPLICATIONS

The present patent application is a continuation-in-part (CIP) of, claims priority to, and makes reference to U.S. non-provisional patent Ser. No. 13/277,300 filed on Oct. 20, 2011, entitled “SYSTEM FOR AGENT ASSISTED MOBILE FUNDS TRANSFER AND MOBILE BANKING”, docket number BRR092011U1. The complete subject matter of the above-referenced United States patent application is hereby incorporated herein by reference in its entirety.

### BACKGROUND

1. Technical Field

The present invention relates generally to blogging; and, more particularly to use of a mobile app for managing and sharing of blog entries with subscribers.

2. Related Art

Cell (mobile) phones are widely used as mobile devices to communicate anywhere in the world. Some of them are very simple devices capable of voice communication alone. Many other today's mobile devices are used for multiple purposes, other than voice communication, in any convenient location. GSM based Cell phones have a SIM card that provides access to cellular networks and support for interactions with a server in a cellular network. These phones also have camera to take photos, and microphones to record voice.

People have been using automatic teller machines (ATM) to withdraw cash from their bank accounts, to deposit checks and to check on account balances. However, using an ATM requires a user to a) have an active bank account, b) use an ATM card and c) have PIN codes or passcodes to gain access to an ATM machine.

Quite a few people, mostly those who are poor or underage, do not have access to such bank accounts, especially those that require a minimum balance of a thousand dollars or so, or those that deduct monthly fees to maintain an account. Such people are cutoff from banking services essentially. They cannot receive money sent by others, as they cannot get wire transfers, they cannot get money transferred through ACH services, etc.

It is very hard, and very expensive otherwise, for poor people who cannot afford to pay monthly fees to maintain a bank account, or to maintain a high minimum balance, to receive money that may be transferred by their family or friends when in need of such funds. It is very difficult for someone to send money to their family members or friends when those intended recipients do not have a bank account, cannot use wire transfer services, cannot have money transferred to their bank accounts somehow, or even cash a check without having a significant portion of that money taken away by check cashing services (especially when they cannot afford such fees), and besides, sending a check to be cashed is a slow process and could take days to be received.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of a system supporting a plurality of users for managing funds transfer and banking

FIG. 2 is a perspective block diagram of a system supporting a plurality of mobile devices used by a plurality of users for managing funds transfer and banking that comprises a server infrastructure communicatively coupled to both a source ATM and a delivering ATM.

FIG. 3 is a perspective block diagram of a system supporting a plurality of mobile devices used by a plurality of users for managing funds transfer and banking.

FIG. 4 is a perspective block diagram of a system that facilitates funds transfer by a sender using a sender's mobile device or a user's laptop/computer both communicatively coupled to a server infrastructure that enables the funds transfer to a recipient via the delivering ATM.

FIG. 5 is a perspective block diagram of a system for funds transfer comprising a server infrastructure that provides several different interfaces for interacting with ATMs, with mobile devices and with PC/laptop/computers of users in order to facilitate funds transfer.

FIG. 6 is an exemplary method 601 of operating a server infrastructure in a system employed by a plurality of users for managing funds transfer and banking using ATMs corresponding ones of a plurality of mobile devices.

### DETAILED DESCRIPTION OF THE DRAWINGS

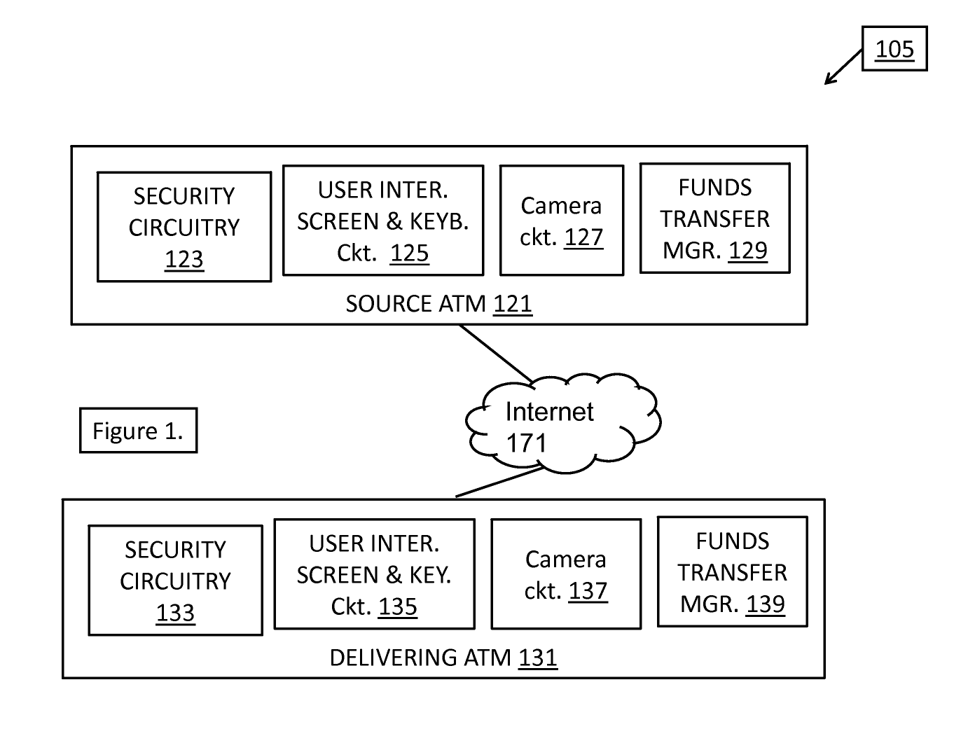

FIG. 1 is a perspective block diagram of a system 105 supporting a plurality of users for managing funds transfer and banking. The system 105 comprises a source automated teller machine (ATM) 121 that initiates a funds transfer of a specified first amount to a recipient based on a funds transfer instructions received from a sender, and a delivering ATM 131 that conducts funds transfer of the specified first amount to the recipient.

The source ATM 121 is used by a sender of funds and the delivering ATM 131 is used by a recipient of funds transferred by the sender. The sender provides an identification of the receiver along with funds (in the form of a cash, or a check, for example) to be transferred to the source ATM 121, and the source ATM 121 communicates the amount to be delivered, along with a transaction id and an optional security token (such as a one-time use security token, for example). The delivering ATM 131 uses it to verify the identity of the recipient before disbursing the transferred funds (in the form of cash, for example). The communication of details of the funds transfer activity occurs in one of several ways—by out of band communication by the sender to the recipient, such as over a phone call or email. It also occurs via an SMS message or instant message sent by the sender to the recipient, or sent by a server of another system communicatively coupled to the source ATM 121, etc. It also occurs in some cases via email sent to the recipient. Other means of communicating the funds transfer details to the recipient and the delivering ATM are also contemplated. The communication of funds transfer details by the sender to the recipient is accompanied by the communication of similar details of the funds transfer transaction to the delivering ATM 131, such communication occurring directly from the source ATM 121 or via a server infrastructure or third party system communicatively coupled to both the source ATM and the delivering ATM.

The source ATM 121 comprises a user interaction screen and keyboard circuitry 125 that helps a user view displayed screens and interact using keyboard, gestures and audio inputs. It also comprises a funds transfer manager 129 that facilitates initiation, conducting, tracking and management of funds transfer activities. It comprises a security manager 123 that facilitates user authentication, verification of user's rights to conduct banking and funds transfer activities, and secure communications of financial transactions and data. It has a camera circuitry 127 that helps capture a picture of the user or a video clip of users activities that can be shared with other ATMs in a network, stored for future reference or forwarded to users on mobile devices for their review and approval, if necessary.

Similarly, the delivering ATM 131 comprises a user interaction screen and keyboard circuitry 135 that helps a user view displayed screens and interact using keyboard, gestures and audio inputs. It also comprises a funds transfer manager 139 that facilitates initiation, conducting, tracking, delivering of funds and management of funds transfer activities. It comprises a security manager 133 that facilitates user authentication, verification of user's rights to conduct banking and funds transfer activities, verification of user input presented by the recipient, and secure communications of financial transactions and data. It has a camera circuitry 137 that helps capture a picture of the user or a video clip of users activities that can be shared with other ATMs in a network, stored for future reference or forwarded to users on mobile devices for their review and approval, such as a sender who initiated a funds transfer, if necessary.

In one embodiment, a sender can use the source ATM 121 to initiate a funds transfer, deliver cash into it, or a check, or select a bank account with sufficient funds available, to be the source of funds. The sender can even use his ATM card to login to the source ATM and provide a passcode or PINcode (such as a 4 digit PINcode) if challenged to be able to use the source ATM 121. Similarly, the recipient uses the delivering ATM 131 to receive funds, providing a transaction id and security information (such as a security token, for example) when prompted by the user interaction screen and keyboard circuitry 135. In a related embodiment, the recipient uses his own ATM card to login to the delivering ATM, and authenticate himself, before being able to get the funds transferred. In a different embodiment, the recipient is only prompted to enter a transaction id and a security information before getting funds (in cash form, for example), and does not have to use his own ATM card to access the funds.

In one embodiment, the sender provides, via the sender's ATM 121 (actually screens provided by user interaction screen & keyboard circuitry 125 of the sender's ATM 121) an identity of the recipient, the source of funds (such as a bank account, cash provided, a check provided, or a credit card information, etc.), and optionally the phone number of the recipient's mobile device to which a notification is to be sent, notifying the sender to come to the location of the delivering ATM to get the funds transferred to him.

In one embodiment, the sender and the recipient need not have any bank accounts to conduct funds transfer using the source ATM and the delivering ATM. In addition, the sender can specify that funds be disbursed only after verification of the recipient by the sender, such as by viewing the sender's digital photo on the sender's mobile device. The recipient's mobile device, if accessible, is used to provide a notification message with details of the funds transfer transaction and details of where the delivering ATM is located.

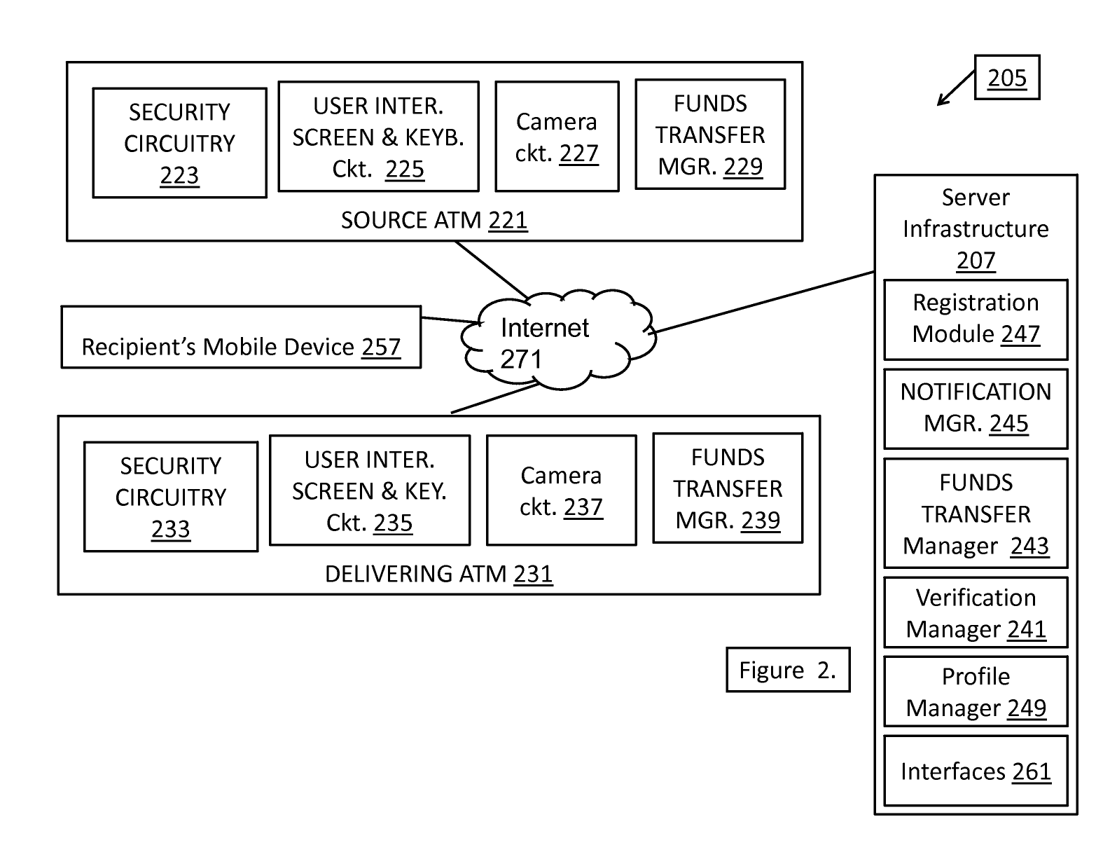

FIG. 2 is a perspective block diagram of a system 205 supporting a plurality of mobile devices used by a plurality of users for managing funds transfer and banking, that comprises a server infrastructure 207 communicatively coupled to both a source ATM 221 and a delivering ATM 231. The server infrastructure 207 comprises a registration module 247 used to register individuals who want to conduct funds transfer and individuals who want to receive funds being transferred, such as those who frequently receive funds. It also comprises a notification manager 245 that facilitates sending notifications of funds to be transferred to recipients, etc. It has a funds transfer manager 243 that facilitates sending funds, receiving funds, tracking funds as they are transferred, reporting on funds transferred, searching for funds that are yet to be transferred, etc. It comprises a verification manager 241 that helps verify transaction ids and security information presented by recipients via the delivering ATM 231, etc. The server infrastructure 207 also comprises a profile manager 249 and interfaces 261, such as a first interface to source ATM 221, a second interface to the delivering ATM 231 and a third interface to a recipient's mobile device 257, etc.

The server infrastructure 207 communicates transaction id, optional security information and the specified first amount to a recipient's mobile device in order to keep a recipient informed on incoming funds. The delivering ATM 231 receives at least the transaction id and the optional security information from the recipient and communicates it to the server infrastructure 207 for verification before conducting funds transfer.

The security information is a security token or a password in one embodiment. In a related embodiment the security token is a one-time use string of alphanumeric digits. It comprises a ATM machine PIN code in another embodiment, that is used in conjunction with the recipients ATM card.

The delivering ATM 231 captures a first digital image of the recipient and sends it to a sender's mobile device via the server infrastructure to seek approval for conducting funds transfer. The delivering ATM 231 receives, via the server infrastructure 207, an approval for funds transfer received from the sender's mobile device, before conducting funds transfer of the specified first amount, minus a service charge, to the recipient.

In one embodiment, the actual delivering ATM 231 recommended to the recipient as a location/facility for funds transfer is determined based on one or more criteria, such as the location of the recipient (as automatically determined or as specified by the sender, for example), the known location of the delivering ATM 231, the known working hours of the delivering ATM, etc. The server infrastructure 207 determines which delivering ATM 231 among several possible ones is to be targeted as the delivering ATM for the recipient, based on perceived convenience and perceived ease of access. The use of other criteria, such as the preferences of the sender, the preferences of the recipient are also factored in a related embodiment. In yet another related embodiment, a primary delivering ATM 231 is specified to the recipient (such as in an email sent or an SMS notification sent, etc.) along with one or more alternate delivering ATMs. The recipient can approach and use any of those delivering ATMs specified—the primary ones or the alternate ones, to complete the funds transfer activities.

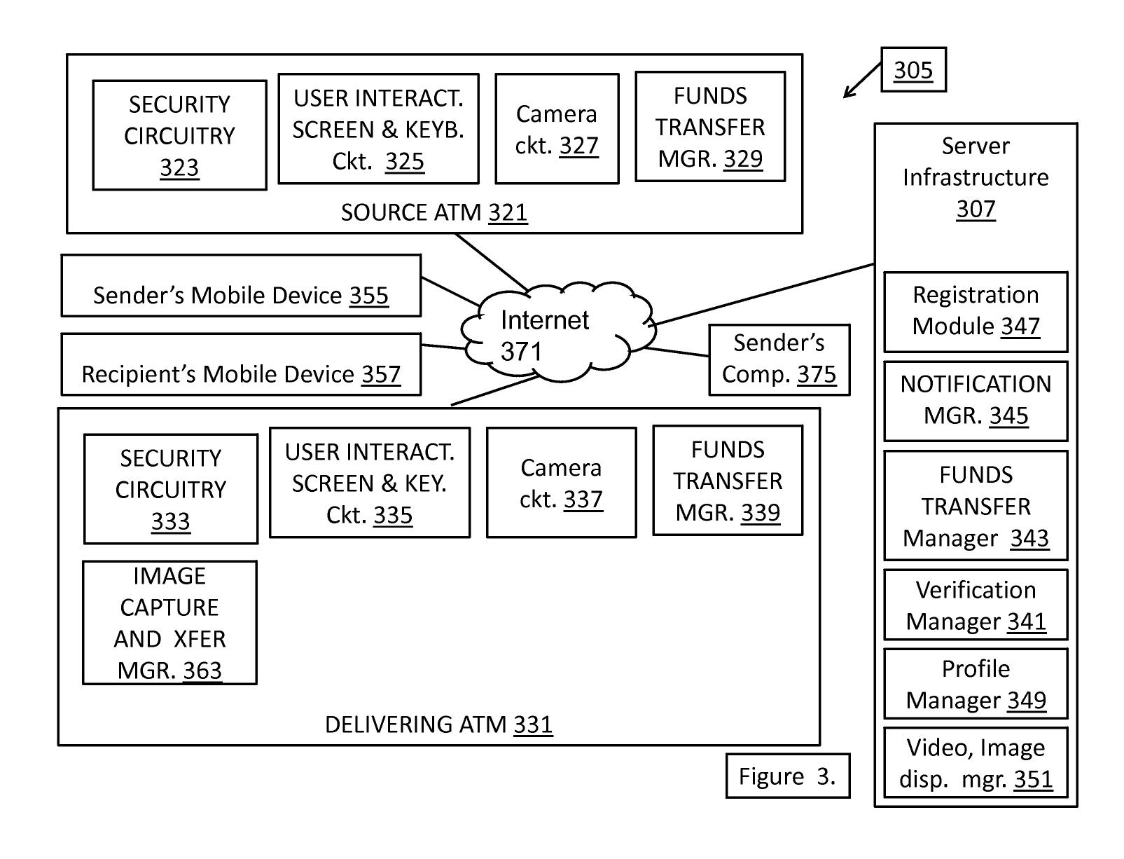

FIG. 3 is a perspective block diagram of a system 305 supporting a plurality of mobile devices used by a plurality of users for managing funds transfer and banking. A user using sender's mobile device 355 initiates a funds transfer to a recipient who receives a notification of the funds transfer on a recipient's mobile device 357. The recipient is provided a transaction id, a security information, or both in a notification received on the recipient's mobile device 357. The security information is a security token or a password in one embodiment. In a related embodiment the security token is a one-time use string of alphanumeric digits. It comprises a ATM machine PIN code in another embodiment, that is used in conjunction with the recipients ATM card.

The delivering ATM 331 captures a first digital image of the recipient and sends it to a sender's mobile device 355 via the server infrastructure 307 to seek approval for conducting funds transfer. The delivering ATM 331 receives, via the server infrastructure 307, an approval for funds transfer received from the sender's mobile device 355, before conducting funds transfer of the specified first amount, minus a service charge, to the recipient.

In one embodiment, the delivering ATM 331 receives the transaction id and the security information from the recipient's mobile device 357 (when it is in communicative proximity) and communicates it to the server infrastructure 307 for verification before conducting funds transfer. In a related embodiment, the identification of the recipient's mobile device 357 is provided by the sender via the source ATM 321 and the delivering ATM 331 accepts the transaction id and the security information only from the recipient's mobile device 357 before proving the transferred funds as cash. The identification of the recipient's mobile device 357 is made by an IMEI number retrieved from the recipient's mobile device 357, by a MSISDN associated the recipient's mobile device 357, by a mobile phone number assigned to the recipient's mobile device 357, etc.

In one embodiment, the identification of the recipient's mobile device 357 is provided by the sender's mobile device 355 to the source ATM 321. In another, the sender himself provides such information using user interaction screen & keyboard circuitry 335 on the delivering ATM 331.

In one embodiment, the source ATM 321 is replaced by a laptop of the sender communicatively coupled to a server infrastructure 307 that initiates a funds transfer of the specified first amount to a recipient based on a funds transfer instructions received from a sender employing an existing financial account with funds available managed by the sender. The delivering ATM 331, communicatively coupled to the server infrastructure 307, conducts funds transfer of the specified first amount to the recipient.

In a different embodiment, the server infrastructure 307 is communicatively coupled to the delivering ATM 351 and to a sender's computer 375. The sender's computer 375 initiates the funds transfer providing instructions for transferring the specified the first amount to the recipient employing a first bank account of the sender (such as a saving account or a checking account of the sender at a local bank). The delivering ATM 331 conducts funds transfer with the specified first amount to the recipient. The server infrastructure 307 facilitates funds transfer between the sender's bank account and the delivering ATM 331. The server infrastructure 307 sends a notification to the recipient's mobile device 357 using the notification manager 345. The server infrastructure 307 compares the transaction id and the security information provided by the recipient's mobile device 357 to a reference transaction id and security information, such as those created during the initiation of the funds transfer transaction. If the comparison results in a perfect match of the transaction id and security information, the server infrastructure 307 approves of the funds transfer and releases the funds to the recipient after the user's approval is received from the sender's mobile device 355, such as after the user activates an approval button after viewing a digital image or a video clip of the recipient captured y and sent by the delivering ATM 331.

In yet another embodiment, the sender initiates the funds transfer by depositing cash or a check into the source ATM 321. The sender's funds thus contributed is transferred to the recipient such that the recipient can withdraw it from the delivering ATM 331. The location of the delivering ATM and the known location of the recipient are often taken into account in determining where exactly the recipient can go to draw the funds transferred. The recipient is informed by the server infrastructure 307 of the location of the delivering ATM 331, the anticipated distance to the delivering ATM 331, the working hours during which access is possible, the charges if any, charged for conducting funds transfer, etc. The recipient is also informed if the sender's approval is requested by sending a digital image of the recipient captured by the delivering ATM 331 or by means of a video clip of the recipient captured by the delivering ATM 331.

The delivering ATM 331 comprises an image capture and transfer manager 363 that facilitates capturing a digital photo or a video clip of the recipient in order to have it displayed to the sender on sender's mobile device 355. This is conducted, in one related embodiment, with the help of the server infrastructure 307, and with the help of a SMS messaging service (not shown) in another. The sender who sees the recipient's digital photo or video clip is prompted to make sure it is indeed the intended recipient before providing an approval message (by activating an APPROVE button presented by an appropriate client application in the sender's mobile device 355, for example). The video, image display manager 351 of the server infrastructure 307 provides the digital photo taken by the camera circuitry 337 or a video taken by the camera circuitry 337 to the sender's mobile device 355 for review by the sender and for approval by the sender before releasing funds to the recipient.

When the sender's computer 375 us used by the sender to initiate funds transfer, the video, image display manager 351 of the server infrastructure 307 provides the digital photo taken by the camera circuitry 337 or a video taken by the camera circuitry 337 to the sender's computer 375 for review by the sender and for approval by the sender.

In one embodiment, the sender initiates the funds transfer by specifying a back account to be used as a source of funds, using the source ATM 221. The server infrastructure 207 employs the sender specified back account to complete the funds transfer, which would involve accessing a sender's total transfer amount. The server infrastructure 207 computes a first amount to be transferred to the recipient by deducting a transaction fee, an ATM service charge or both, from a sender's total transfer amount provided by the sender from the sender's bank account.

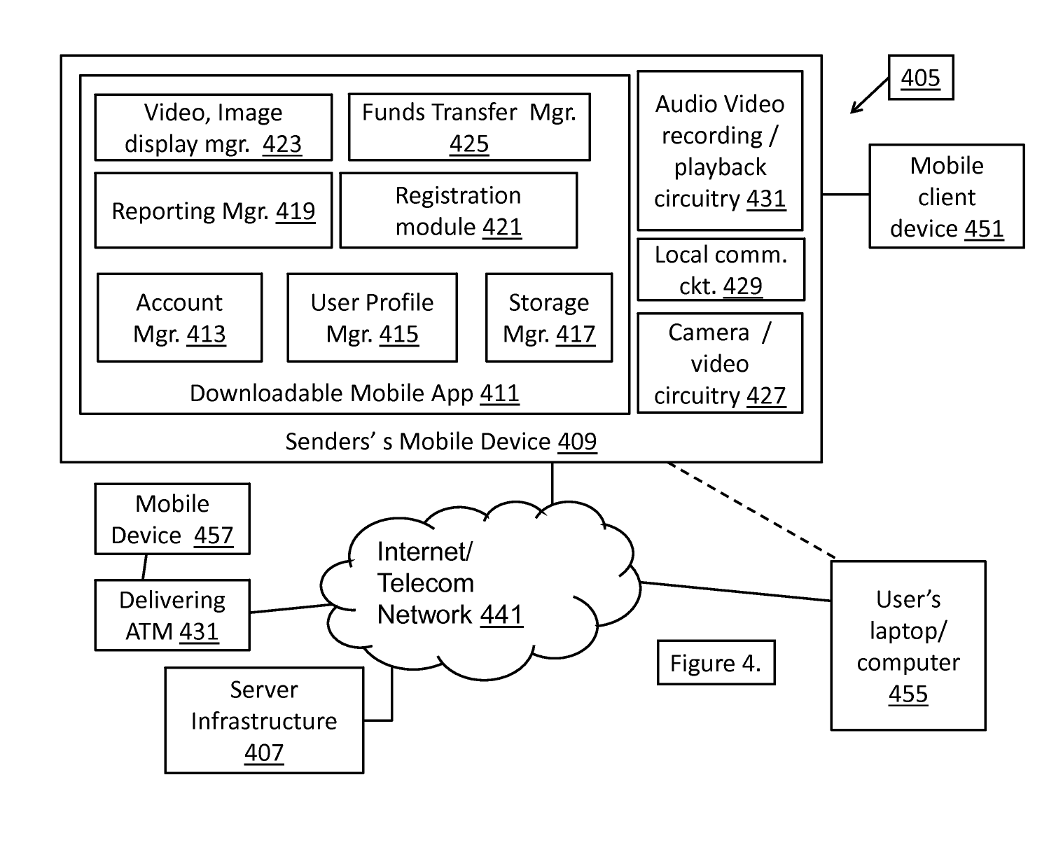

FIG. 4 is a perspective block diagram of a system 405 that facilitates funds transfer by a sender using a sender's mobile device 409 or a user's laptop/computer 455 both communicatively coupled to a server infrastructure 407 that enables the funds transfer to a recipient via the delivering ATM 431. The mobile device 457 used by the recipient is identified by the sender as that being used by the recipient, and the server infrastructure 407 sends a notification to the mobile device 457 of the recipient providing all details of the funds transfer transaction including the amount to be transferred, the location of the delivering ATM 457 (alternate delivering ATMs are also specified), the transaction id, any security information, etc.

The recipient employs the mobile device 457 to communicate the transaction details to the delivering ATM in order to initiate the completion of the funds transfer operations. The delivering ATM 431 is also capable of providing user interaction screens that the recipient can use to enter the particulars of the funds transfer transactions and security information, in order to have funds provided as cash (or as a check, etc.).

A downloadable mobile app 411 available in the sender's mobile device 409 facilitates funds transfer, the display of an image or video of the recipient for sender review, the solicitation of approval of funds transfer by the sender just before funds are delivered to the recipient, etc. The downloadable mobile app 411 in the sender's mobile device 409 comprises a video, image display manager 419 that displays an image or video of the recipient, while a funds transfer manager 425 simultaneously seeks approval of the funds transfer from the sender. A profile of the sender is maintained by the downloadable mobile app 411, which is shared with the server infrastructure 407 as necessary, to enable frequent funds transfer or to enable communication of sender's preferences of recipients and locations where delivering ATMs need to be identified for frequently targeted recipients.

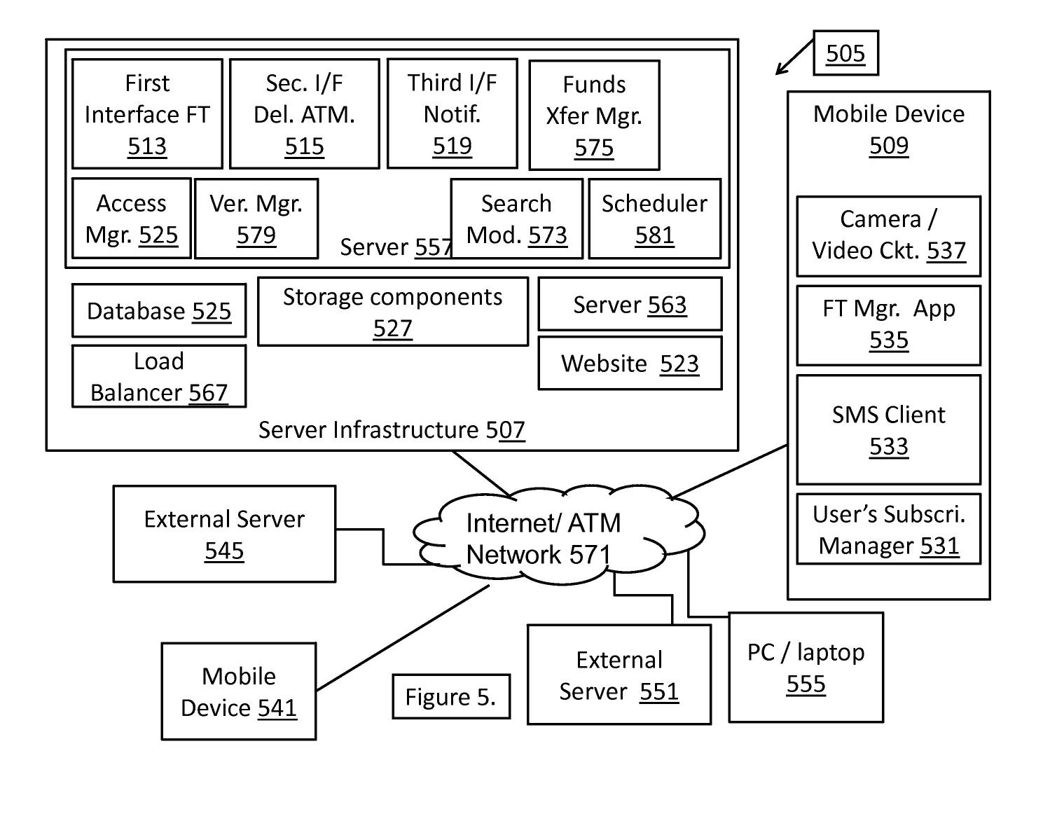

FIG. 5 is a perspective block diagram of a system for funds transfer 505 comprising a server infrastructure 507 that provides several different interfaces for interacting with ATMs, with mobile devices and with PC/laptop/computers of users in order to facilitate funds transfer. The server infrastructure 507 comprises a first interface 513 for funds transfer 513 that a sender can use to interact with using the sender's ATM, a PC/laptop 555 or a mobile device 509. The sender provides an identity of the recipient, the source of funds (such as a bank account, cash provided, a check provided, or a credit card information, etc.), and the phone number of the recipient's mobile device 541. For example, the server infrastructure 507 uses the first interface 513 to receive a funds transfer instructions from a sender sending a first funds transfer.

The server infrastructure 507 also comprises a second interface 515 used by the delivering ATM to initiate delivery of funds, provide verification services that help verify if the recipient is the right one and if the transaction is the right one, and enable solicitation of a sender approval prior to funds disbursement (such as via an digital photo or video of the recipient captured and conveyed by the delivering ATM). For example, the server infrastructure 507 uses the second interface to communicate a funds delivery instructions for the first funds transfer to a delivering ATM. These instructions comprise authentication needs if any, verification instructions, instructions on need for sender's review of photo or video prior to disbursement, a time limit for completion, currency exchange rates, etc. It also receives a digital photo or video taken by the delivering ATM (of the recipient, for example) via the second interface.

The server infrastructure 507 also comprises a third interface 519 used for communicating notifications to recipients on their recipient mobile device 541. For example, the third interface is used to send an SMS message to the recipient's mobile device 541 informing the recipient of where to get the funds being transferred, when to get it, and transaction details such as transaction id, security information, etc. For example, the third interface is used to communicate a notification about the first funds transfer to a recipient mobile device along with an address of the delivering ATM where the recipient can use his mobile device 541 to complete the funds transfer interactions (using the mobile device 541 or screens provided by the delivering ATM).

The server infrastructure 507 also comprises a search module 573 that enables searching of fund transfers not yet completed, funds transfers waiting for a particular recipient, all fund transfers transactions initiated by any sender, etc. It comprises a scheduler 581 that enables scheduling of funds delivery to specific recipients, where such funds delivery is coordinated by the recipient himself using the mobile device 541 (actually an appropriate funds transfer mobile app in the mobile device 541), or where the funds pickup is scheduled by the sender himself during initiation of funds transferred. The server infrastructure 507 also allows a sender to specify the exact delivering ATM (based on location preferences, bank preferences, network preferences, time preferences, etc.) to be used for delivery to a recipient, rather than determine one on behalf of the sender.

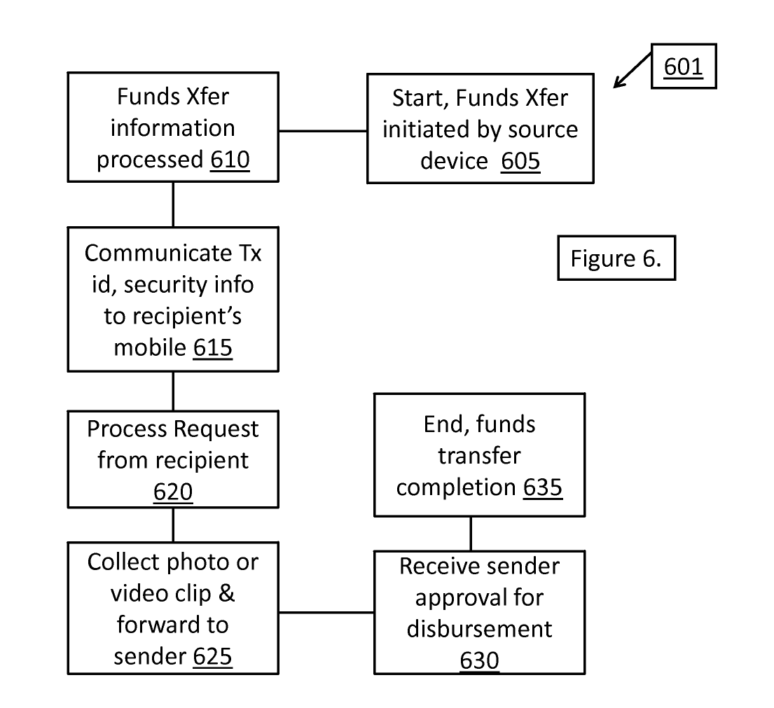

FIG. 6 is an exemplary method 601 of operating a server infrastructure in a system employed by a plurality of users for managing funds transfer and banking using ATMs corresponding ones of a plurality of mobile devices. At a start block 605, the processing starts when a source device, such as a sender's ATM or a laptop/PC used by the sender, initiates funds transfer operations and the server infrastructure gets a signal or a request indicating initiation of funds transfer, such a signal often coming from a source of funds transfer—a source ATM or a sender's PC/laptop. For example, a source device contacts the server infrastructure to initiate a funds transfer of a specified first amount provided by the sender as cash or a check, to be transferred and delivered to a recipient, based on a funds transfer instructions received from the sender.

Then, at a next block 610, the funds transfer information provided by the sender is noted and processed by the server infrastructure—such information comprising the identity of the recipient, a mobile device phone number of the recipient often providing at least a portion of such recipient identity. In addition, sender's preferences and profile are optionally passed. The preferences include, for example, sender's request for “verification” of recipient before disbursement of funds, such verification including display of a photo or video of recipient captured by the delivering ATM. The preferences also include a specific delivering ATM to be used, or a specific bank to be used in a specific geographical region in the determination of an ATM.

Then, at a next block 615, the server infrastructure communicatively coupled to both the source ATM and the delivering ATM communicates a transaction id, a security information and the specified first amount to a recipient's mobile device in the form of a notification. In one embodiment, the notification is sent as an SMS message. In a related embodiment, it is sent as an email. In yet another related embodiment, the notification is sent as a phone call or as a multimedia message.

At a next block 620, the server infrastructure receives from the delivering ATM a signal or request from recipient indicating an attempt by the recipient to access the funds transferred. At a next block 625, the server infrastructure collects a digital photo or a video clip of the recipient collected by the delivering ATM, and forwards it to the sender's mobile device for review and approval by the sender. At a next block 630, the server infrastructure receives sender approval for disbursement of funds based on the specified first amount and indicates the same to the delivering ATM.

Finally at an end block 635, the server infrastructure receives a funds transfer completion message from the delivering ATM and records it. In addition, it reports it to the sender via email or via a message sent to the sender's mobile device.

In one embodiment, the server infrastructure delivers, to the delivering ATM, the transaction id and the security information to be received by the delivering ATM from the recipient, so that it may conduct local verification and not have the server infrastructure be involved in such verification.

In one embodiment, the server infrastructure receives from the delivering ATM, a first digital image of the recipient, which it then compares to a previously stored image of the recipient and attempts to determine a match. If it finds a match, it communicates an approval message to the delivering ATM in order to release transferred funds to the recipient. If it does not find a match, it then conducts the operation specified in step 625 above in order to seek the sender's review and approval, sending the captured first digital image to a sender's mobile device, to seek approval for conducting funds transfer.

In one embodiment, the server infrastructure, in step 630, after receiving an approval for funds transfer from the sender's mobile device deducts a service charge or a transaction fee from the specified first amount, i.e. it conducts funds transfer of the specified first amount, minus a service charge or a transaction fee to the recipient.

In one embodiment, when the source device is a source ATM, at the step 605, the sender is expected to specify to the server infrastructure the mobile phone number of the recipient, and preferably a name of a city or region where the recipient is resident, and a delivering ATM identification if the sender knows that information. In a related embodiment, where the source device is a user's laptop/personal device communicatively coupled to the server infrastructure the sender is expected to provide a bank account from which the sender is expected to conduct funds transfer. For example, a checking account or a savings account of the sender, or a credit card of the sender, is used to conduct funds transfer.

In one embodiment, the server infrastructure 507 used for supporting funds transfer comprises a first interface 513 to receive a funds transfer instructions from a sender sending a first funds transfer, and a second interface 515 to communicate a funds delivery instructions for the first funds transfer to a delivering ATM. It also comprises a third interface 519 to communicate a notification about the first funds transfer to a recipient mobile device. The server infrastructure 507 receives, via the second interface 515, a verification request with recipient input provided by the delivering ATM 331, wherein the recipient input is collected by the delivering ATM 331 from the recipient. The server infrastructure 507 communicates a verification result back to the delivering ATM after verifying the validity of the recipient input.

The server infrastructure 507 also receives, via the second interface 515, a digital image of the recipient sent by the delivering ATM 331, and, in response, communicates it via the first interface 513 for display to the sender.

In a related embodiment, the second interface 515 is an interface to an ATM network that connects ATMs of different banks and permits these ATMs to interact with the ATM cards and provide services to users of those ATM cards. In another related embodiment, the first interface 513 and the second interface 515 are interfaces to an ATM network. In another embodiment, the first interface 513 is a web interface that supports user interactions and banking transactions (and provides a secure access to a website for funds transfer and banking) and the second interface 515 is an interface to an ATM network.

The terms “server” and “server infrastructure” as used herein may refer to a set of computing machines, such as those in data centers, or to a portion of a hosted and managed computing services, that performs multiple underlying computational functions and supports various network access, network storage, data manipulation and searching activities. “Server infrastructure” may also refer to scalable configurations of cloud computing resources with middleware, databases and websites. The term “mobile device” as used herein may refer to handheld computers, tablets, mini-tablets, cellular phones, smartphones and personal digital assistants.

The term ATM as used herein may refer to automated teller machines used by banks and other financial institutions that are used by users with bank cards, debit cards or credit cards to withdraw funds, make deposits, make balance inquiries, etc.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Circuits and circuitry may comprise general or specific purpose hardware, or may comprise such hardware and associated software such as firmware or object code.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A system supporting a plurality users for managing funds transfer and banking, the system comprising:
a source automated teller machine (ATM) that initiates a funds transfer of a specified first amount to a recipient based on a funds transfer instructions received from a sender; and
a delivering ATM that conducts funds transfer of the specified first amount to the recipient.

2. The system of claim 1 further comprising:
a server infrastructure communicatively coupled to both the source ATM and the delivering ATM;
the server infrastructure communicates a transaction id, optional security information and the specified first amount to a recipient's mobile device; and
the delivering ATM receives at least the transaction id and the optional security information from the recipient and communicates it to the server infrastructure for verification before conducting funds transfer.

3. The system of claim 2 wherein the security information is a security token or a password, the system further comprising:
the delivering ATM captures a first digital image of the recipient and sends it a sender's mobile device via the server infrastructure to seek approval for conducting funds transfer; and
the delivering ATM receives, via the server infrastructure, an approval for funds transfer received from the sender's mobile device, before conducting funds transfer of the specified first amount, minus a service charge, to the recipient.

4. The system of claim 2 wherein the delivering ATM receives the transaction id and the security information from the recipient's mobile device and communicates it to the server infrastructure for verification before conducting funds transfer.

5. The system of claim 2 wherein the identification of the recipient's mobile device is provided by the sender via the source ATM.

6. The system of claim 2 wherein the identification of the recipient's mobile device is provided by the sender's mobile device to the source ATM.

7. The system of claim 1 wherein the source ATM is replaced by a laptop of the sender communicatively coupled to a server infrastructure that initiates a funds transfer of the specified first amount to a recipient based on a funds transfer instructions received from a sender employing an existing financial account with funds available managed by the sender; and
the delivering ATM, communicatively coupled to the server infrastructure, conducts funds transfer of the specified first amount to the recipient.

8. The system of claim 1 further comprising:
a server infrastructure communicatively coupled to the delivering ATM and to a sender's computer;
the sender's computer initiates the funds transfer providing instructions for transferring the specified the first amount to the recipient employing a first bank account of the sender; and
the delivering ATM conducts funds transfer with the specified first amount to the recipient.

9. The system of claim 1 wherein the sender initiates the funds transfer by depositing cash or a check into the source ATM.

10. The system of claim 1 wherein the sender initiates the funds transfer by specifying a back account to be used as a source of funds, using the source ATM.

11. The system of claim 1 wherein the specified first amount is computed by deducting a transaction fee, an ATM service charge or both, from a sender's total transfer amount provided by the sender.

12. A method for a system employed by a plurality of users for managing funds transfer and banking using corresponding ones of a plurality of mobile devices, the method comprising:
initiating, by a source device, a funds transfer of a specified first amount to a recipient based on a funds transfer instructions received from a sender, wherein the source device is a source ATM or a user's personal device communicatively coupled to a server infrastructure; and
conducting, by a delivering ATM, funds transfer of the specified first amount to the recipient.

13. The method of claim 12 further comprising:
communicating a transaction id, a security information and the specified first amount to a recipient's mobile device, by the server infrastructure communicatively coupled to both the source ATM and the delivering ATM;
receiving, by the delivering ATM, the transaction id and the security information from the recipient; and
communicating the transaction id and the security information to the server infrastructure for verification before conducting funds transfer to the recipient.

14. The method of claim 12 further comprising:
capturing, by the delivering ATM, a first digital image of the recipient;
sending the captured first digital image to a sender's mobile device, via the server infrastructure to seek approval for conducting funds transfer; and
receiving, by the delivering ATM, via the server infrastructure, an approval for funds transfer received from the sender's mobile device, before conducting funds transfer of the specified first amount, minus a service charge to the recipient.

15. A server infrastructure for supporting funds transfer, the server infrastructure comprising:
a first interface to receive a funds transfer instructions from a sender sending a first funds transfer;
a second interface to communicate a funds delivery instructions for the first funds transfer to a delivering ATM; and
a third interface to communicate a notification about the first funds transfer to a recipient mobile device.

16. The server infrastructure of claim 15 further comprising:
the server infrastructure receives, via the second interface, a verification request with recipient input provided by the delivering ATM, wherein the recipient input is collected by the delivering ATM from the recipient; and
the server infrastructure communicates a verification result back to the delivering ATM after verifying the validity of the recipient input.

17. The server infrastructure of claim 15 further comprising:
the server infrastructure receives, via the second interface, a digital image of the recipient sent by the delivering ATM, and, in response, communicates it via the first interface for display to the sender.

18. The server infrastructure of claim 15 wherein the second interface is an interface to an ATM network that connects ATMs of different banks and permits these ATMs to interact with the ATM cards and provide services to users of those ATM cards.

19. The server infrastructure of claim 15 wherein the first interface and the second interface are interfaces to an ATM network.

20. The server infrastructure of claim 15 wherein the first interface is a web interface that supports user interactions and banking transactions and the second interface is an interface to an ATM network.
